(19) United States
(12) Patent Application Publication
(10) Pub. No.: US 2018/0350024 A1
(43) Pub. Date: Dec. 6, 2018

(54) Baggage Management for Mobility-As-A-Service

(71) Applicant: AT&T Intellectual Property I, L.P., Atlanta, GA (US)

(72) Inventor: David Kaufman, Atlanta, GA (US)

(73) Assignee: AT&T Intellectual Property I, L.P., Atlanta, GA (US)

(21) Appl. No.: 15/614,652

(22) Filed: Jun. 6, 2017

(51) Int. Cl. G06Q 50/30; G06Q 50/14; G06Q 10/08

(52) U.S. Cl. CPC G06Q 50/30; G06Q 10/0833; G06Q 50/14

(57) ABSTRACT

Concepts and technologies disclosed herein are directed to baggage management for Mobility-as-a-Service (“MaaS”). According to one aspect of the concepts and technologies disclosed herein, a MaaS system can receive a request that indicate that a user desires a baggage service to manage baggage associated with the user while the user is traveling. The MaaS system can determine a route to deliver the baggage to a location. The MaaS system can assign a vehicle to deliver the baggage to the location in accordance with the determined route. The MaaS system also can inform a driver associated with the vehicle to deliver the baggage to the location in accordance with the route. In some embodiments, the request also indicates that the user desires a ride service to transport the user to a different location than the location specified for the baggage.

### BACKGROUND

Transportation is a fundamental part of today's society. City congestion, sprawl, financial considerations, and other factors have lead many people to abandon their personal transportation in favor of shared transportation. In particular, services that provide transportation-on-demand, known in the art as Mobility-as-a-Service (“MaaS”) or Transportation-as-a-Service (“TaaS”) services, including, for example, UBER and LYFT, have grown significantly in recent years and have emerged as the preferred method of transportation for many people, primarily those living in metropolitan areas and those that do not desire and/or cannot afford personal transportation. Moreover, many in a generation of people who are now reaching driving age have little to no interest in driving and, for this reason, postpone or never pursue their driver's license and instead rely on other forms of personal transportation, such as walking or riding a bicycle, to meet their everyday transportation needs, and rely on MaaS offerings, such as UBER and LYFT, when farther travel is required.

### SUMMARY

Concepts and technologies disclosed herein are directed to baggage management for MaaS. According to one aspect of the concepts and technologies disclosed herein, a MaaS system can receive a request that indicate that a user desires a baggage service to manage baggage associated with the user while the user is traveling. The MaaS system can determine a route to deliver the baggage to a location. The MaaS system can assign a vehicle to deliver the baggage to the location in accordance with the determined route. The MaaS system also can inform a driver associated with the vehicle to deliver the baggage to the location in accordance with the route.

In some embodiments, the MaaS system can determine that the final baggage destination is known (e.g., the request specifies the final baggage destination). In these embodiments, the location includes the final baggage destination. In other embodiments, the MaaS system can determine that the final baggage destination unknown. In these embodiments, the location can include a baggage storage facility at which the baggage is to be stored until the final baggage destination is known. In some embodiments, the MaaS system can receive the final baggage destination and can determine a further route to deliver the baggage to the final baggage destination. The MaaS system can assign a transfer vehicle to transfer the baggage to the final baggage destination in accordance with the further route. The MaaS system can inform a further driver associated with the transfer vehicle to deliver the baggage to the final baggage destination.

In some embodiments, the request also can indicate that the user desires a ride service to transport the user to a different location than the location. In these embodiments, the MaaS system can receive a final ride and baggage delivery request that includes a final destination for both the user and the baggage. The MaaS system can determine a baggage location at which the baggage is located and a user location at which the user is located. The MaaS system can determine a further route by which the baggage is to be picked up at the baggage location and the user is to be picked up at the user location. The MaaS system can then assign the further route to at least one further vehicle for the baggage and the user to be transported to the final destination.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment for various concepts disclosed herein.

FIG. 2 is a flow diagram illustrating aspects of a method for providing baggage management for MaaS, according to an illustrative embodiment of the concepts and technologies disclosed herein.

FIG. 3 is a flow diagram illustrating aspects of a method for final ride and baggage delivery, according to an illustrative embodiment of the concepts and technologies disclosed herein.

FIG. 4 is a flow diagram illustrating aspects of a method for changing a final baggage destination, according to an illustrative embodiment of the concepts and technologies disclosed herein.

FIG. 5 is a flow diagram illustrating aspects of a method for providing a baggage location update, according to an illustrative embodiment of the concepts and technologies disclosed herein.

FIG. 6 is a block diagram illustrating an example computer system capable of implementing aspects of the embodiments presented herein.

FIG. 7 is a block diagram illustrating an example mobile device capable of implementing aspects of the embodiments disclosed herein.

FIG. 8 is a diagram illustrating a network, according to an illustrative embodiment.

### DETAILED DESCRIPTION

Concepts and technologies disclosed herein are directed to baggage management for MaaS. MaaS offerings, such as UBER and LYFT, have grown significantly in the last few years, prompting many people to use MaaS for at least some of their transportation needs. The use of MaaS, however, has revealed new challenges. For example, in a current MaaS environment, a traveler (also referred to herein as a “user”) can request a ride in a MaaS vehicle and must take their baggage with them after the ride. In other words, the traveler cannot leave their baggage with the MaaS vehicle if the traveler desires to travel unencumbered. The concepts and technologies disclosed herein address this challenge, at least in part, by allowing a user to delegate management of their baggage to a MaaS provider such that the MaaS provider takes possession of the baggage and then returns the baggage to the user at a place and time chosen by the user.

When traveling with baggage, a user must either keep the baggage in their possession or find a place to securely store the baggage. In the case of a user visiting several locations (e.g., points of interest on a vacation or different companies on a business trip), the user either would have to find a suitable place to store the baggage or haul the baggage to each location. It is common practice for users to leave their baggage at a hotel. This solution has several limitations. For example, the user must have stayed at the hotel (which is unlikely during day trips); the user will have to return to the hotel to pick up the baggage; and, in many cases, the user's final destination is not near the starting point (i.e., the hotel in this example) which means an additional trip. Moreover, prior to increased security due to terrorism and other risks, another solution was for the user to rent a storage space, such as a storage locker, at a transportation hub (e.g., an airport or railway station). The aforementioned risks, however, have made this practice virtually obsolete.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, vehicles, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of baggage management for MaaS will be described.

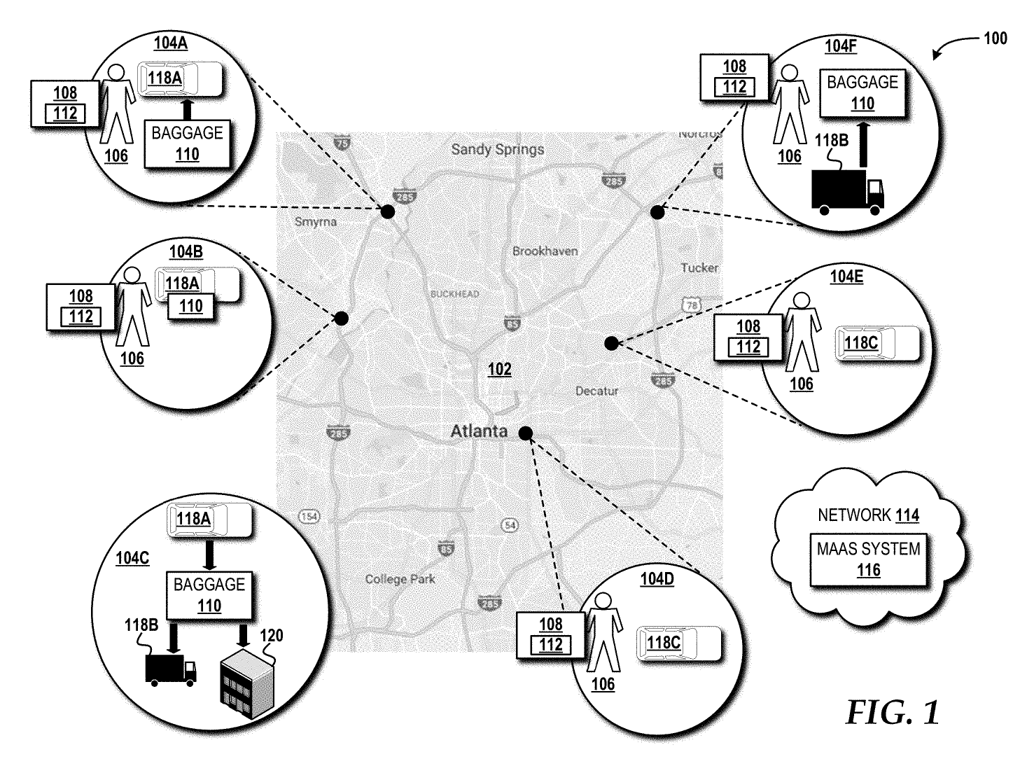

Referring now to FIG. 1, aspects of an illustrative operating environment 100 for various concepts disclosed herein will be described. It should be understood that the operating environment 100 and the various components thereof have been greatly simplified for purposes of discussion. Accordingly, additional or alternative components of the operating environment 100 can be made available without departing from the embodiments described herein.

The operating environment 100 includes a map 102 illustrating a plurality of locations 104A-104F (collectively, “locations 104”). A first location 104A illustrates a user 106 (also referred to herein as a “traveler”), a user device 108, and baggage 110. The user 106 is shown as traveling alone, however, the user 106 might travel with other users/travelers (not shown). The other users/travelers might be part of the same party as the user 106, a different party, or traveling alone and separately from the user 106. The user device 108 can be a cellular phone such as a feature phone or a smartphone, a mobile computing device such as a tablet computing device or laptop, a smart watch, a portable video game console, or the like. The baggage 110 includes one or more personal belongings associated with the user 106. The personal belongings can be packed in a suitcase, bag, or other luggage. Alternatively, the personal belongings can be standalone—that is, not packed in a suitcase, bag, or other luggage. The baggage 110 can contain belongings packed and standalone. The personal belongings can be owned by the user 106, although this is not necessary. The personal belongings can be owned by another individual or entity (e.g., business) and the user 106 can act as at least a temporary custodian thereof. The baggage 110 is not limited to any particular thing or collection of things. It should be understood that the baggage 110 can have any physical characteristics in terms of size, weight, and/or other dimension(s).

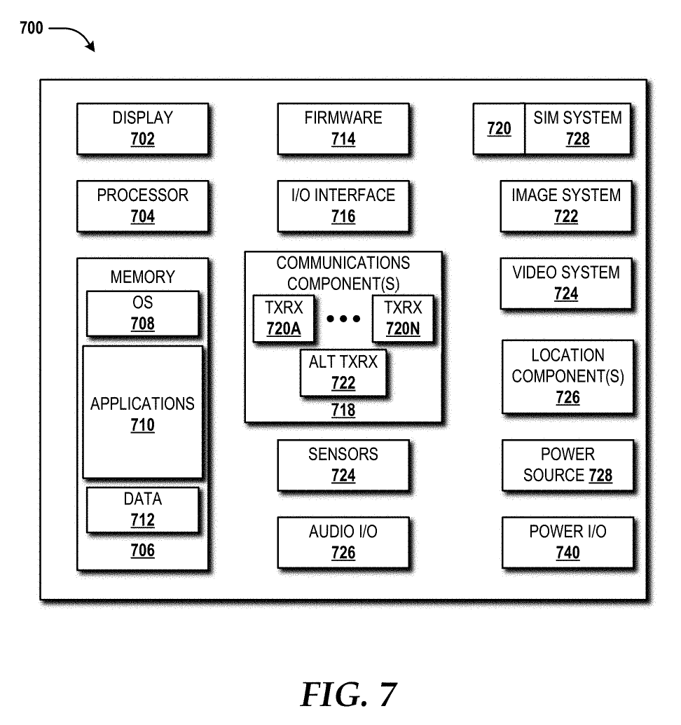

In the illustrated embodiment, the user device 108 is embodied as a smartphone that can execute, via one or more processors (best shown in FIG. 7), a MaaS application 112 that communicates, via a network 114, with a MaaS system 116 associated with a MaaS provider to coordinate transportation for the user 106 and the baggage 110 among at least some of the locations 104. The MaaS provider can provide transportation services via a fleet of vehicles, which might be owned by the MaaS provider and operated by employees of the MaaS provider. The MaaS provider can provide transportation services via a fleet of vehicles that are individually owned and operated by employees of the MaaS provider. The MaaS provider can provide transportation services via vehicles owned by individuals who are working as contractors for the MaaS provider. Those skilled in the art will appreciate that other business models can be implemented by a MaaS provider.

In some embodiments, the MaaS application 112 operates as a client-side application that communicates with a server-side application executed by the MaaS system 116. By way of example and not limitation, the MaaS application 112 can request a ride for the user 106 based upon input provided by the user 106 regarding their transportation needs, including a pickup time, a pickup location (e.g., the first location 104A for this leg of the trip), a preferred vehicle size (e.g., based upon passenger capacity, baggage capacity, or both), a price the user 106 is willing and able to pay, and whether baggage service is requested. The MaaS system 116 can receive requests from the MaaS application 112 via the network 114 and can process the request by determining a vehicle and driver suitable to meet of the transportation needs specified in the request. If all transportation needs cannot be met, the MaaS system 116 can inform the user 106 via a message sent to the MaaS application 112. The MaaS application 112 can, in response, provide the user 106 with an option to cancel the ride request or accept a ride without all transportation needs met.

In the illustrated example, the user 106 has requested transportation from the first location 104A to a second location 104B for him/herself and the baggage 110. In response, the MaaS system 116 has deployed a driver of a first vehicle 118A to the location 104A for transporting the user 106 and the baggage 110 to the second location 104B. At the second location 104B, the user 106 has decided to leave the baggage 110 with the first vehicle 118A and to retrieve the baggage 110 at a later time at a different location. The first driver, via the first vehicle 118A, can, in accordance with instructions received from the MaaS system 116, make trips to other locations, pickup/drop-off other travelers, pickup/drop-off other baggage, and can eventually drop off the baggage 110 with a second vehicle 118B or a baggage storage facility 120 (shown, for ease of explanation and not limitation, together at a third location 104C) to, at least in part, prepare for delivery of the baggage 110 to the user 106 at the later time and at the different location. The user 106 then travels to a fourth location 104D and a fifth location 104E via a third vehicle 118C deployed by the MaaS system 116. The user 106 eventually arrives at a sixth location 104F, which was designated by the user 106 as the final destination for the baggage 110. Accordingly, the MaaS system 116 arranges delivery of the baggage 110 to the sixth location 104F via the second vehicle 118B.

In some embodiments, the baggage 110 is assigned a baggage claim identifier (not shown), which can be depicted as any combination of letter, numbers, and/or on a tag, sticker, or other object affixed to the baggage 110. Additionally, the baggage claim identifier can be associated with the user 106 in the MaaS system 116. A user ID, such as an account number, telephone number, name, and/or the like, can be associated with the baggage claim identifier in a database (not shown) managed by the MaaS system 116. The database can be part of the MaaS system 116 or external to and in communication with the MaaS system 116.

Each of the vehicles 118A-118C can be a car, truck, van, motorcycle, moped, go-kart, golf cart, or any other land-based vehicle configured to transport one or more passengers and/or cargo (e.g., the baggage 110). One or more of the vehicles 118A-118C can be driven by a person. One or more of the vehicles 118A-118C, in some embodiments, is capable of operating in at least a partially autonomous control mode. One or more of the vehicles 118A-118C, in some embodiments, is a fully autonomous vehicle, which might have a “driver” on-board for emergency situations. In some embodiments, one or more of the vehicles 118A-118C can operate as a level 3 or level 4 vehicle as defined by the National Highway Traffic Safety Administration (“NHTSA”). The NHTSA defines a level 3 vehicle as a limited self-driving automation vehicle that enables a driver to cede full control of all safety-critical functions under certain traffic or environmental conditions, and in those conditions to rely heavily on the vehicle to monitor for changes that require transition back to driver control. In a level 3 vehicle, the driver is expected to be available for occasional control, but with sufficiently comfortable transition time. The GOOGLE car, available from GOOGLE, is an example of a limited self-driving automation vehicle. The NHTSA defines a level 4 vehicle as a full self-driving automation vehicle that is designed to perform all safety-critical driving functions and monitor roadway conditions for an entire trip to a destination. Such a design anticipates that a user will provide destination or navigation input, but is not expected to be available for control at any time during the trip. This includes both occupied and unoccupied vehicles. The vehicles 118A-118C can include any combination of the aforementioned vehicle types and can have any combination of capabilities with regard to autonomy. Although the vehicles 118A-118C are described in context of land transportation, one or more of the vehicles 118A-118C can be capable of air transportation and/or water transportation in addition to or as an alternative to land transportation. In some embodiments, one or more of the vehicles 118A-118C can operated in multiple modes, which can include any combination of a land mode, an air mode, or a water mode.

The network 114 provides a communications path between the user device 108 and the MaaS system 116. The network 114 also provides a communications path between the MaaS system 116 and the vehicles 118A-118C and/or device(s) that provide communications capabilities for the vehicles 118A-118C. Although the MaaS system 116 is illustrated as being part of the network 114, the MaaS system 116 can be separate from the network 114 and can communicate with the network 114 through one or more other networks (not shown). In some embodiments, the network 114 is provided, at least in part, by the MaaS provider associated with the MaaS system 116.

The network 114 can be or can include one or more wireless wide area networks (“WWANs”), which may, in turn, include one or more core networks such as a circuit-switched core network (“CS CN”), a packet-switched core network (“PS CN”), an IP multimedia subsystem (“IMS”) core network, an evolved packet core (“EPC”), multiples thereof, and/or combinations thereof. The WWAN can utilize one or more mobile telecommunications technologies, such as, but not limited to, Global System for Mobile communications (“GSM”), Code Division Multiple Access (“CDMA”) ONE, CDMA2000, Universal Mobile Telecommunications System (“UMTS”), LTE, Worldwide Interoperability for Microwave Access (“WiMAX”), other 802.XX technologies (e.g., 802.11 WI-FI), and the like. The network 114 can include one or more radio access networks (“RANs”) that each can utilize one or more channel access methods (which might or might not be used by the aforementioned standards) including, but not limited to, Time Division Multiple Access (“TDMA”), Frequency Division Multiple Access (“FDMA”), Single Carrier FDMA (“SC-FDMA”), CDMA, wideband CDMA (“W-CDMA”), Orthogonal Frequency Division Multiplexing (“OFDM”), Space Division Multiple Access (“SDMA”), and/or the like to provide a radio/air interface to the user device 108 and the vehicles 118A-118C (to receive instructions from the MaaS system 116). Data communications can be provided in part by the RAN(s) using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. Moreover, a RAN may be a GSM RAN (“GRAN”), a GSM EDGE RAN (“GERAN”), a UMTS Terrestrial Radio Access Network (“UTRAN”), an E-UTRAN (such as in the example provided herein), any combination thereof, and/or the like.

It should be understood that some implementations of the operating environment 100 include a different number of locations 104, users 106, user devices 108, MaaS applications 112, networks 114, vehicles 118, or any combination thereof. The operating environment 100 can include more or less baggage 110. The operating environment 100 can include multiple MaaS systems 116. Thus, the illustrated embodiment should be understood as being illustrative, and should not be construed as being limiting in any way.

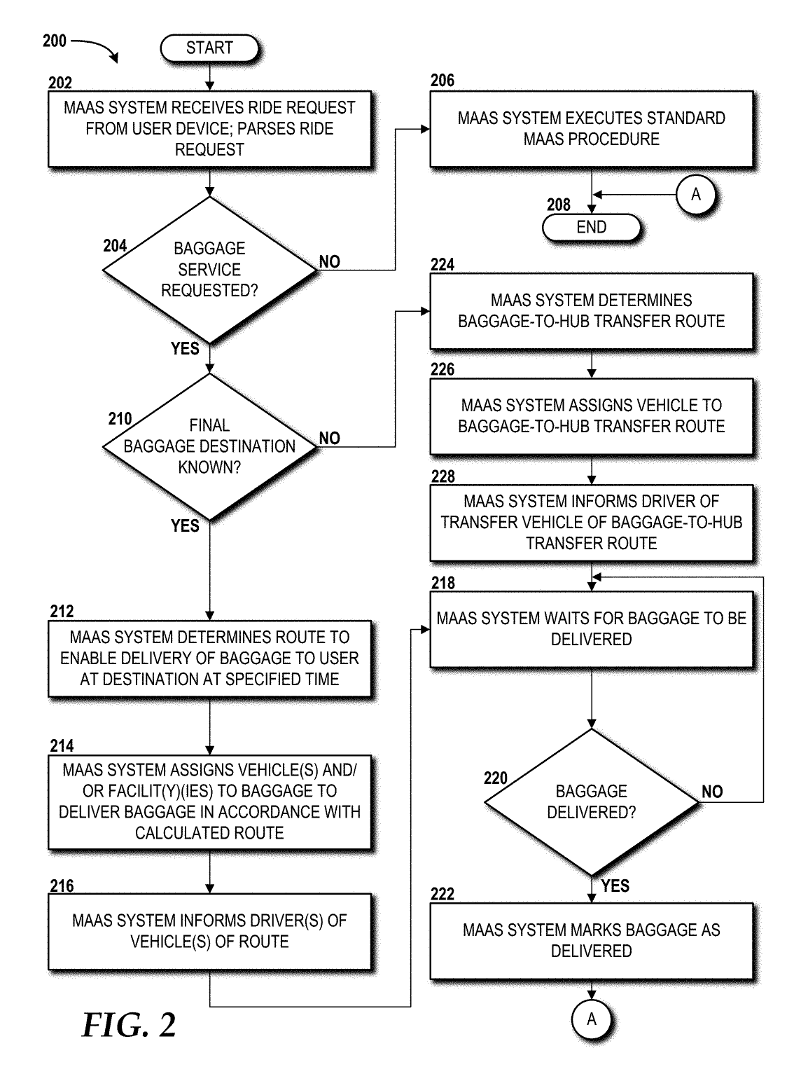

Turning now to FIG. 2, a flow diagram illustrating aspects of a method 200 for providing baggage management for MaaS will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems or devices, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors of one or more computing systems and/or devices disclosed herein to perform operations.

For purposes of illustrating and describing some of the concepts of the present disclosure, operations of the methods disclosed herein are described as being performed, at least in part, by the MaaS system 116 via execution, by one or more processors, of one or more software modules. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described with reference to FIG. 2 and further reference to FIG. 1. The method 200 begins and proceeds to operation 202, where the MaaS system 116 receives a ride request from the user device 108 and parses the ride request to determine the transportation needs of the user 106. For example, the ride request can include a pickup time, a pickup location, a user destination location, a preferred vehicle size, a price the user 106 is willing to pay, name, telephone number, other personally identifying information, any combination thereof, and the like. In addition, the ride request can include an indication of whether the user 106 desires baggage service to deliver the baggage 110 to a baggage destination location at a time of the user's 106 choosing. It should be understood that the user destination location and the baggage destination can be different locations. The ride request can be generated by the MaaS application 112 executing on the user device 108. In some embodiments, the MaaS application 112 can present a graphical user interface (“GUI”) through which the user 106 can specify their transportation needs. Alternatively, the ride request can be received via a telephone call, whereby the user 106 can express their transportation needs to a live agent or an automated system.

From operation 202, the method 200 proceeds to operation 204, where the MaaS system 116 determines if baggage service is requested. If baggage service is not requested, the method 200 proceeds to operation 206, where the MaaS system 116 executes a standard MaaS procedure. For example, the MaaS system 116 can instruct one or more drivers of the vehicles 118 to serve the user 106 without baggage service—that is, transport the user 106 from the pickup location to the user destination location. From operation 206, the method 200 proceeds to operation 208, where the method 200 ends.

Returning to operation 204, if baggage service is requested, the method 200 proceeds to operation 210, where the MaaS system 116 determines if the final baggage destination is known. The final baggage destination can be included in the ride request. If the final baggage destination is specified in the ride request, the method 200 proceeds to operation 212, where the MaaS system 116 determines a route to enable delivery of the baggage 110 to the user 106 at the final baggage destination specified in the ride request. If the user 106 also has included a specified delivery time, the route can be determined by the MaaS system 116 to deliver the baggage 110 by the specified delivery time. In some embodiments, the MaaS system 116 can present a cost to the user 106, which the user 106 can accept or deny. If the user 106 denies the cost, the method 200 can end (this operation is not illustrated in the method 200).

The route can include transportation of the baggage 110 via one or more of the vehicles 118 and can include, optionally, temporary storage at one or more facilities 120 prior to the baggage 110 being transported to the final baggage destination. The MaaS system 116 can utilize optimization parameters such as, but not limited to, MaaS usage patterns (e.g., overall for a given fleet of vehicles or on a per vehicle basis), MaaS service demand, traffic patterns, real-time traffic data, or any combination thereof to determine a route to enable delivery of the baggage 110 to the user 106 at the final baggage destination specified in the ride request. MaaS usage patterns and trends can be determined by the Maas provider by analysis of system usage data. For any given day of the week and time of day, such analysis can identify probabilistic patterns of where riders are likely to be requesting rides and where they are likely to go. MaaS providers can utilize this data in concert with baggage delivery request parameters (destination and time) to optimize driver-to-hub, driver-to-driver-to-hub, or driver-to-driver-to-passenger routing. This optimization can be further enhanced by considering traffic patterns and real-time traffic data.

For example, a driver may pick up a passenger at an airport at 9:00 AM who is requesting a ride to the main business district. The rider may further desire to have the MaaS service keep his luggage and deliver it to him at the airport at 7:00 PM that evening. A simple routing of the baggage would be for the initial driver to return the baggage to a hub near the airport as soon as he drops off the rider. That may mean driving back to the airport in high traffic without a return fare. The MaaS system 116 can utilize usage patterns to let the driver provide rides to new customers while in the main business district until such time that an airport ride is requested, or until favorable traffic conditions exist. The MaaS system 116 also can optimize the route based on the driver's work schedule, allowing him to transfer the baggage to another driver in the main business district who may work later in the day. The MaaS system 116 also can operate mobile baggage hubs (e.g., vans or other transfer vehicles) that can accumulate baggage in a high traffic area and then deliver the baggage-to-static hubs at key locations, such as airports, once a critical load of baggage has accumulated and traffic patterns are favorable, thereby significantly reducing the number of trips made to transfer baggage.

From operation 212, the method 200 proceeds to operation 214, where the MaaS system 116 assigns one or more of the vehicles 118 and/or one or more baggage storage facilities 120 to handle the baggage 110 in accordance with the determined route. From operation 214, the method 200 proceeds to operation 216, where the MaaS system 116 informs the driver(s) of the vehicles 118 of the route assigned at operation 214. The MaaS system 116 can inform the driver(s) of the vehicles 118 via a telephone call, a text message, an in-vehicle computer system (e.g., navigation or infotainment system), and/or an driver MaaS application operating on a device (e.g., a smartphone) associated with one or more of the driver(s) and/or one or more of the vehicle(s) 118. The method by which the MaaS system 116 informs the driver(s) of the vehicles 118 can utilize proprietary messaging technology utilized by the MaaS provider.

From operation 216, the method 200 proceeds to operation 218, where the MaaS system 116 waits for the baggage 110 be delivered. From operation 218, the method 200 proceeds to operation 220, where the MaaS system 116 determines if the baggage 110 has been delivered to the final baggage destination. If not, the MaaS system 116 continues to wait for the baggage to be delivered per operation 218. When the MaaS system 116 determines, at operation 220, that the baggage 110 has been delivered, the method 200 proceeds to operation 222, where the MaaS system 116 marks the baggage 110 as delivered. In some embodiments, the baggage 110 also can be tracked to ensure that the baggage 110 was still in possession of an assigned vehicle/driver associated with the MaaS provider and to determine which vehicle/driver had possession of the baggage 110 in case the user 106 requires the baggage 110 before it is delivered to the final baggage destination. In some embodiments, a driver or other entity, such as the user 106, can inform the MaaS system 116 that the baggage 110 has been delivered. In some embodiments, the MaaS application 112 executed by the user device 108 can include functionality to receive input of the baggage identifier associated with the baggage 110 and send the baggage identifier to the MaaS system 116 as part of a baggage claiming procedure. In some embodiments, the baggage identifier can be provided in a 2-D or 3-D barcode that can be scanned by the user device 108 and/or another device, such as a driver's device. The baggage identifier, in other embodiments, can be input via image recognition. Those skilled in the art will appreciate the numerous baggage claiming procedures that can be used to determine that the baggage 110 has been delivered.

From operation 222, the method 200 proceeds to operation 208. The method 200 ends at operation 208.

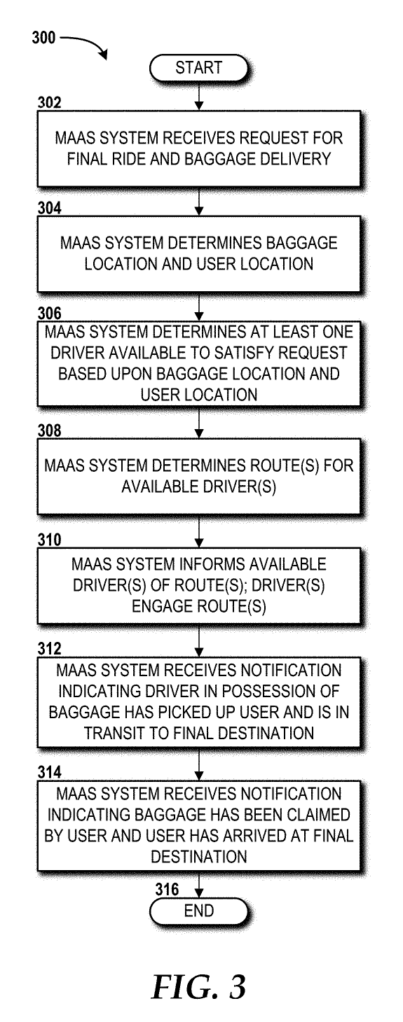

Returning to operation 210, if the MaaS system 116 determines that the final baggage destination is unknown, the method 200 proceeds to operation 224, where the MaaS system 116 determines a baggage-to-hub transfer route. A baggage-to-hub transfer route includes a route from the baggage pickup location to a hub (e.g., the storage facility 120) where the baggage 110 can be stored. The baggage 110 can be stored at the hub until a final baggage destination is known. From operation 224, the method 200 proceeds to operation 226, where the MaaS system 116 assigns one or more of the vehicles 118 to deliver the baggage 110 to the hub along the baggage-to-hub transfer route. From operation 214, the method 200 proceeds to operation 226, where the MaaS system 116 informs the driver(s) of the vehicles 118 assigned at operation 226 of the baggage-to-hub transfer route. The baggage 110 is then delivered via one or more of the vehicles 118 to the selected hub. The hub stores the baggage until a final baggage destination is known. Details in this regard are provided herein below with reference to the method 300 of FIG. 3. From operation 228, the method 200 proceeds to operation 218, where the method 200 continues as described above.

Turning now to FIG. 3, a method 300 for final ride and baggage delivery will be described, according to an illustrative embodiment. The method 300 begins and proceeds to operation 302, where the MaaS system 116 receives a request for final ride and baggage delivery. From operation 302, the method 300 proceeds to operation 304, where the MaaS system 116 determines a baggage location and a user location. When the baggage 110 is delivered to a hub, such as the storage facility 120, the baggage 110 can be marked in a database as stored in that location. For example, the baggage 110 identified by a baggage identifier can be associated with a location identifier that uniquely identifies the storage facility 120. This can be a simple identifier that associates a number, letter, word, symbol, or any combination thereof to the storage facility 120. A street address, latitude/longitude coordinates, and/or other location identifiers are also contemplated. Upon receiving a request for baggage delivery, the MaaS system 116 can consult the database to determine the baggage location. The user's location can be based upon a last known location of the user; for example, a previous destination such as the fifth location 104E in FIG. 1. Alternatively, the user's location can include a current location of the user 106 based upon a location determining technique (e.g., Global Positioning System “GPS”) implemented, at least in part, by the user device 108, or a request sent to the MaaS application 112 to prompt the user 106 to provide their current location. The user's location can include a new pickup location that the user 106 or the MaaS provider specifies, or a mutually agreed upon location. For purposes of explanation, it will be assumed that the baggage location is the third location 104C (at the storage facility 120) and the user location is the fifth location 104E.

From operation 304, the method 300 proceeds to operation 306, where the MaaS system 116 determines at least one driver available to satisfy the request based upon the baggage location and the user location. From operation 306, the method 300 proceeds to operation 308, where the MaaS system 116 determines one or more routes for the available driver(s). From operation 308, the method 300 proceeds to operation 310, where the MaaS system 116 informs the available driver(s) of the route(s) determined at operation 308 and the available driver(s) engage the route(s). From operation 310, the method 300 proceeds to operation 312, where the MaaS system 116 receives a notification indicating a driver in possession of the baggage 110 has picked up the user 106 and is in transit to the final destination. From operation 312, the method 300 proceeds to operation 314, where the MaaS system 116 receives a notification indicating that the baggage 110 has been claimed by the user 106 and the user 106 has arrived at the final destination. From operation 314, the method 300 proceeds to operation 316, where the method 300 ends.

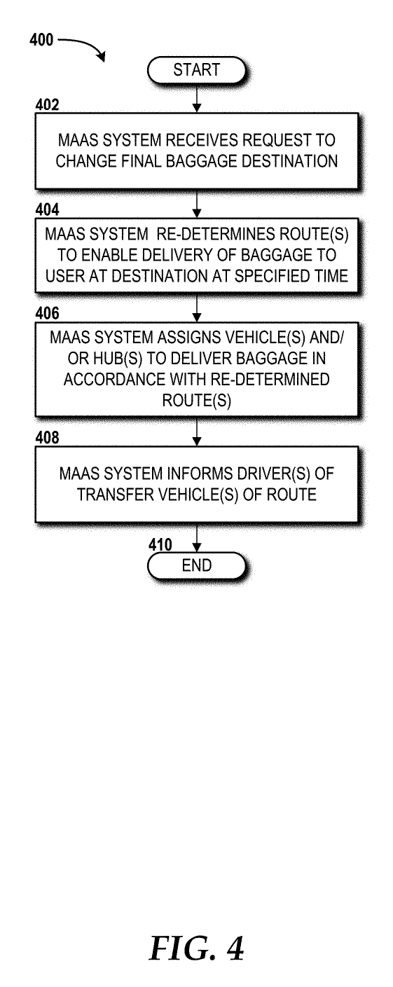

Turning now to FIG. 4, a method 400 for changing a final baggage destination will be described, according to an illustrative embodiment. The method 400 begins and proceeds to operation 402, where the MaaS system 116 receives a request to change the final baggage destination. From operation 402, the method 400 proceeds to operation 404, where the MaaS system 116 re-determines the route(s) to enable delivery of baggage to the user 106 at the destination at the specified time. From operation 404, the method 400 proceeds to operation 406, where the MaaS system 116 assigns one or more vehicles 118 and/or one or more hubs to deliver baggage in accordance with the re-determined route(s). From operation 406, the method 400 proceeds to operation 408, where the MaaS system 116 informs the driver(s) of the vehicle(s) 118 of the route. From operation 408, the method 400 proceeds to operation 410, where the method 400 ends.

The MaaS system 116 can establish one-to-one correspondence between baggage and driver (or hub) each time a change of state (i.e., handoff) is made. In the case of a driver or mobile hub, the real-time location of the driver or hub can be communicated to the MaaS system 116 so that the MaaS system 116 always knows current baggage location. If a change of delivery location and time are made, then the MaaS system 116 can re-optimize delivery of the baggage and route accordingly based upon the current position of the baggage as the starting point.

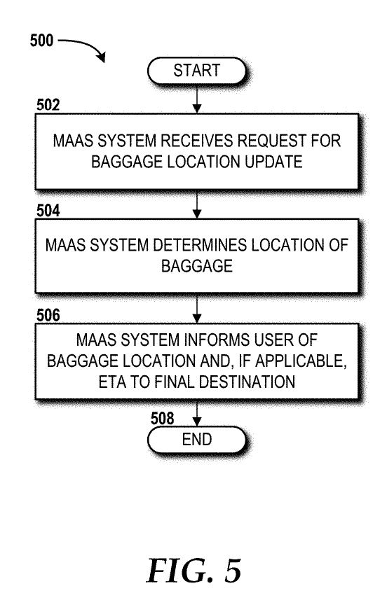

Turning now to FIG. 5, a method 500 for providing a baggage location update, according to an illustrative embodiment. The method 500 begins and proceeds to operation 502, where the MaaS system 116 receives a request for a baggage location update. From operation 502, the method 500 proceeds to operation 504, where the MaaS system 116 determines the location of the baggage 110. From operation 504, the method 500 proceeds to operation 506, where the MaaS system 116 informs the user 106 of the baggage location and, if applicable, an estimated time of arrival at the final destination. From operation 506, the method 500 proceeds to operation 508, where the method 500 ends.

To implement the method 500, the baggage 110 can be tracked. In some embodiments, a radio frequency identification (“RFID”) tag can be attached to the baggage 110. The RFID tag can be scanned by the driver. Tags can be provided to drivers by the MaaS provider in advance and can be reused after the baggage 110 is delivered. In other embodiments, barcode stickers or the like, such as described above, can be used in place of RFID tags. The barcode stickers can be scanned by the driver's device at time of acceptance of the baggage 110 and that information can be communicated to the MaaS system 116 until delivery has been made. In some other embodiments, a digital image can be used to tag the baggage 110. For example, the driver can take a picture of the baggage 110 and that image can be matched at each handoff along the way. Automated imaging devices and image recognition technologies are also contemplated.

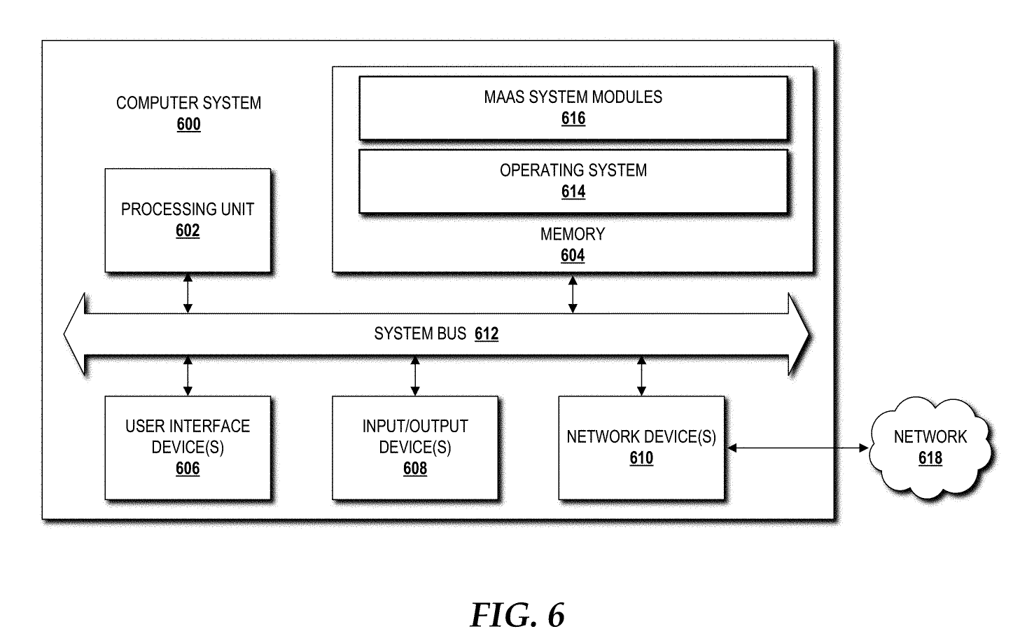

FIG. 6 is a block diagram illustrating a computer system 600 configured to perform various operations disclosed herein. The computer system 600 includes a processing unit 602, a memory 604, one or more user interface devices 606, one or more input/output (“I/O”) devices 608, and one or more network devices 610, each of which is operatively connected to a system bus 612. The system bus 612 enables bi-directional communication between the processing unit 602, the memory 604, the user interface devices 606, the I/O devices 608, and the network devices 610. In some embodiments, the user device 108, one or more components of the network 114, the MaaS system 116 or one or more components thereof, one or more components of the vehicle(s) 118, or some combination thereof is/are configured, at least in part, like the computer system 600. It should be understood, however, that one or more of these elements may include additional functionality or include less functionality than now described.

The processing unit 602 may be a standard central processor that performs arithmetic and logical operations, a more specific purpose programmable logic controller (“PLC”), a programmable gate array, or other type of processor known to those skilled in the art and suitable for controlling the operation of the computer system 600. Processing units are generally known, and therefore are not described in further detail herein.

The memory 604 communicates with the processing unit 602 via the system bus 612. In some embodiments, the memory 604 is operatively connected to a memory controller (not shown) that enables communication with the processing unit 602 via the system bus 612. The illustrated memory 604 includes an operating system and one or more applications 616.

The operating system 614 can include, but is not limited to, members of the WINDOWS, WINDOWS CE, WINDOWS MOBILE, and/or WINDOWS PHONE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like.

The user interface devices 606 may include one or more devices with which a user accesses the computer system 600. The user interface devices 606 may include, but are not limited to, computers, servers, personal digital assistants, telephones (e.g., cellular, IP, or landline), or any suitable computing devices. The I/O devices 608 enable a user to interface with the program modules. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, a touchscreen, or an electronic stylus. Further, the I/O devices 608 may include one or more output devices, such as, but not limited to, a display screen or a printer.

The network devices 610 enable the computer system 600 to communicate with other networks or remote systems via a network 618 (e.g., the network 114 shown in FIG. 1). Examples of the network devices 610 include, but are not limited to, a modem, a radio frequency (“RF”) or infrared (“IR”) transceiver, a telephonic interface, a bridge, a router, or a network card. The network 618 may include a wireless network such as, but not limited to, a WLAN such as a WI-FI network, a WWAN, a wireless PAN (“WPAN”) such as BLUETOOTH, or a wireless MAN (“WMAN”). Alternatively, the network 618 may be a wired network such as, but not limited to, a WAN such as the Internet, a LAN such as the Ethernet, a wired PAN, or a wired MAN.

Turning now to FIG. 7, an illustrative mobile device 700 and components thereof will be described. In some embodiments, the user device 108 is configured the same as or similar to the mobile device 700. A driver's device (not shown) also can be configured the same as or similar to the mobile device 700. In some embodiments, the mobile device 700 is configured to integrate with a vehicle 118 to provide various functionality described herein for the drivers. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display network connection information, various graphical user interface (“GUI”) elements, text, images, video, virtual keypads and/or keyboards, messaging data, notification messages, metadata, Internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in the memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in data communications, entering/deleting data, entering and setting user IDs and passwords for device access, configuring settings, manipulating content and/or settings, multimode interaction, interacting with other applications 710, and otherwise facilitating user interaction with the operating system 708, the applications 710, and/or other types or instances of data 712 that can be stored at the mobile device 700.

The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks described herein. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments, one or more of the transceivers of the communications component 718 may be configured to communicate using GSM, CDMAONE, CDMA2000, LTE, and various other 2G, 2.5G, 3G, 4G, 5G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-720N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 700 or other devices or computers described herein, such as the computer system 600 described above with reference to FIG. 6. For purposes of the claims, the phrase “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 700 in order to store and execute the software components presented herein. It is also contemplated that the mobile device 700 may not include all of the components shown in FIG. 7, may include other components that are not explicitly shown in FIG. 7, or may utilize an architecture completely different than that shown in FIG. 7.

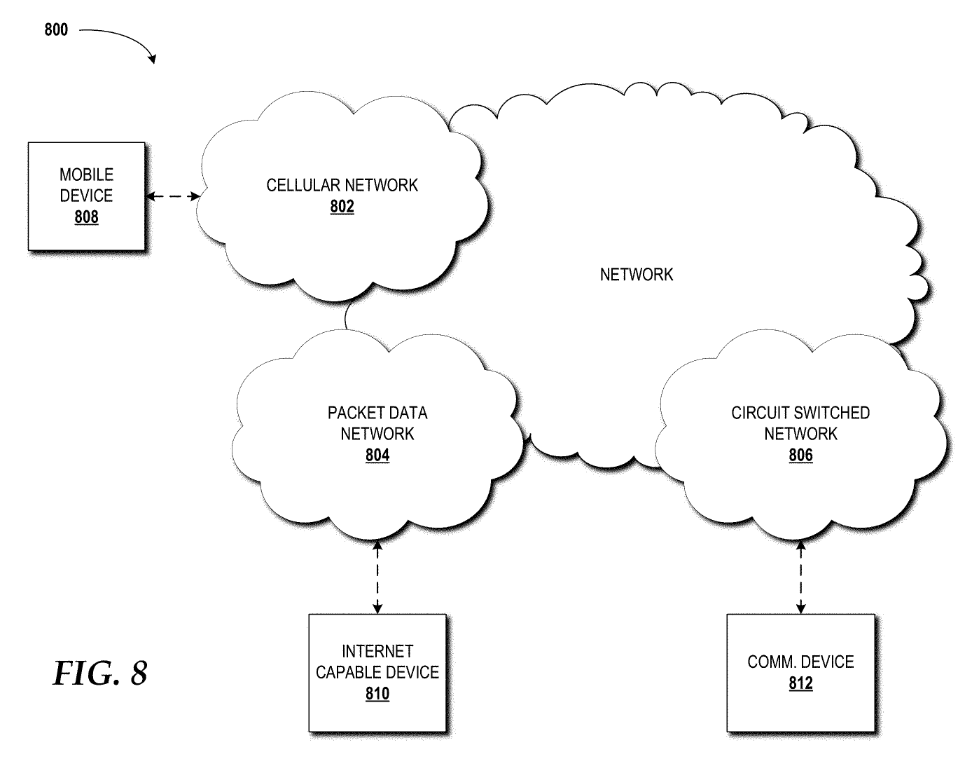

Turning now to FIG. 8, details of a network 800 are illustrated, according to an illustrative embodiment. The network 800 includes a cellular network 802, a packet data network 804, and a circuit switched network 806 (e.g., a public switched telephone network). The network 800 can include the network 114 illustrated and described with reference to FIG. 1.

The cellular network 802 includes various components such as, but not limited to, base transceiver stations (“BTSs”), NodeBs or eNodeBs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 802 also includes radios and nodes for receiving and transmitting voice, data, and combinations thereof to and from radio transceivers, networks, the packet data network 804, and the circuit switched network 806.

A mobile communications device 812, such as, for example, the user device 108, a cellular telephone, a user equipment, a mobile terminal, a PDA, a laptop computer, a handheld computer, a component of the vehicle(s) 118, and combinations thereof, can be operatively connected to the cellular network 802. The cellular network 802 can be configured as a 2G GSM network and can provide data communications via GPRS and/or EDGE. Additionally, or alternatively, the cellular network 802 can be configured as a 3G UMTS network and can provide data communications via the HSPA protocol family, for example, HSDPA, EUL (also referred to as HSUPA), and HSPA+. The cellular network 802 also is compatible with 4G mobile communications standards such as LTE, or the like, as well as evolved and future mobile standards.

The packet data network 804 includes various devices, for example, servers, computers, databases, and other devices in communication with another, as is generally known. In some embodiments, the packet data network 804 is or includes one or more WI-FI networks, each of which can include one or more WI-FI access points, routers, switches, and other WI-FI network components. The packet data network 804 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 804 includes or is in communication with the Internet. The circuit switched network 806 includes various hardware and software for providing circuit switched communications. The circuit switched network 806 may include, or may be, what is often referred to as a plain old telephone system (“POTS”). The functionality of a circuit switched network 806 or other circuit-switched network are generally known and will not be described herein in detail.

The illustrated cellular network 802 is shown in communication with the packet data network 804 and a circuit switched network 806, though it should be appreciated that this is not necessarily the case. One or more Internet-capable devices 810, for example, a PC, a laptop, a portable device, or another suitable device, can communicate with one or more cellular networks 802, and devices connected thereto, through the packet data network 804. It also should be appreciated that the Internet-capable device 810 can communicate with the packet data network 804 through the circuit switched network 806, the cellular network 802, and/or via other networks (not illustrated).

As illustrated, a communications device 812, for example, a telephone, facsimile machine, modem, computer, or the like, can be in communication with the circuit switched network 806, and therethrough to the packet data network 804 and/or the cellular network 802. It should be appreciated that the communications device 812 can be an Internet-capable device, and can be substantially similar to the Internet-capable device 810.

Based on the foregoing, it should be appreciated that concepts and technologies for baggage management for MaaS have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

I claim:

1. A method comprising:
receiving, by a Mobility-as-a-Service (“MaaS”) system comprising a processor, a request from a user device associated with a user, wherein the request indicates that the user desires a baggage service to manage baggage associated with the user while the user is traveling;
determining, by the MaaS system, a route to deliver the baggage to a location;
assigning, by the MaaS system, a vehicle to deliver the baggage to the location in accordance with the route; and
informing, by the MaaS system, a driver associated with the vehicle to deliver the baggage to the location in accordance with the route.

2. The method of claim 1, further comprising determining, by the MaaS system, based upon the request, that a final baggage destination is known; and wherein the location comprises the final baggage destination.

3. The method of claim 2, wherein the request specifies the final baggage destination.

4. The method of claim 1, further comprising determining, by the MaaS system, based upon the request, that a final baggage destination is unknown; and wherein the location comprises a baggage storage facility at which the baggage is to be stored until the final baggage destination is known.

5. The method of claim 4, further comprising:
receiving, by the MaaS system, the final baggage destination;
determining, by the MaaS system, a further route to deliver the baggage to the final baggage destination;
assigning, by the MaaS system, a transfer vehicle to transfer the baggage to the final baggage destination in accordance with the further route; and
informing, by the MaaS system, a further driver associated with the transfer vehicle to deliver the baggage to the final baggage destination.

6. The method of claim 1, wherein the request also indicates that the user desires a ride service to transport the user to a different location than the location.

7. The method of claim 6, further comprising:
receiving, by the MaaS system, a final ride and baggage delivery request comprising a final destination for both the user and the baggage;
determining, by the MaaS system, a baggage location at which the baggage is located;
determining, by the MaaS system, a user location at which the user is located;
determining, by the MaaS system, a further route by which the baggage is to be picked up at the baggage location and the user is to be picked up at the user location; and
assigning, by the MaaS system, the further route to at least one further vehicle for the baggage and the user to be transported to the final destination.

8. A computer-readable storage medium comprising computer-executable instructions that, when executed by a processor, causes the processor to perform operations comprising:
receiving a request from a user device associated with a user, wherein the request indicates that the user desires a baggage service to manage baggage associated with the user while the user is traveling;
determining a route to deliver the baggage to a location;
assigning a vehicle to deliver the baggage to the location in accordance with the route; and
informing a driver associated with the vehicle to deliver the baggage to the location in accordance with the route.

9. The computer-readable storage medium of claim 8, wherein the operations further comprise determining, based upon the request, that a final baggage destination is known; and wherein the location comprises the final baggage destination.

10. The computer-readable storage medium of claim 9, wherein the request specifies the final baggage destination.

11. The computer-readable storage medium of claim 8, wherein the operations further comprise determining, based upon the request, that a final baggage destination is unknown; and wherein the location comprises a baggage storage facility at which the baggage is to be stored until the final baggage destination is known.

12. The computer-readable storage medium of claim 11, wherein the operations further comprise:
receiving the final baggage destination;
determining a further route to deliver the baggage to the final baggage destination;
assigning a transfer vehicle to transfer the baggage to the final baggage destination in accordance with the further route; and
informing a further driver associated with the transfer vehicle to deliver the baggage to the final baggage destination.

13. The computer-readable storage medium of claim 1, wherein the request also indicates that the user desires a ride service to transport the user to a different location than the location.

14. The computer-readable storage medium of claim 13, wherein the operations further comprise:
receiving a final ride and baggage delivery request comprising a final destination for both the user and the baggage;
determining a baggage location at which the baggage is located;
determining a user location at which the user is located;
determining a further route by which the baggage is to be picked up at the baggage location and the user is to be picked up at the user location; and
assigning the further route to at least one further vehicle for the baggage and the user to be transported to the final destination.

15. A Mobility-as-a-Service system comprising:
a processor; and
memory that stores instructions that, when executed by the processor, cause the processor to perform operations comprising
receiving a request from a user device associated with a user, wherein the request indicates that the user desires a baggage service to manage baggage associated with the user while the user is traveling,
determining a route to deliver the baggage to a location,
assigning a vehicle to deliver the baggage to the location in accordance with the route, and
informing a driver associated with the vehicle to deliver the baggage to the location in accordance with the route.

16. The Mobility-as-a-Service system of claim 15, wherein the operations further comprise determining, based upon the request, that a final baggage destination is known; and wherein the location comprises the final baggage destination.

17. The Mobility-as-a-Service system of claim 16, wherein the request specifies the final baggage destination.

18. The Mobility-as-a-Service system of claim 15, wherein the operations further comprise determining, based upon the request, that a final baggage destination is unknown; and wherein the location comprises a baggage storage facility at which the baggage is to be stored until the final baggage destination is known.

19. The Mobility-as-a-Service system of claim 18, wherein the operations further comprise:
receiving the final baggage destination;
determining a further route to deliver the baggage to the final baggage destination;
assigning a transfer vehicle to transfer the baggage to the final baggage destination in accordance with the further route; and
informing a further driver associated with the transfer vehicle to deliver the baggage to the final baggage destination.

20. The Mobility-as-a-Service system of claim 15, wherein the request also indicates that the user desires a ride service to transport the user to a different location than the location; and wherein the operations further comprise:
receiving a final ride and baggage delivery request comprising a final destination for both the user and the baggage;
determining a baggage location at which the baggage is located;
determining a user location at which the user is located;
determining a further route by which the baggage is to be picked up at the baggage location and the user is to be picked up at the user location; and
assigning the further route to at least one further vehicle for the baggage and the user to be transported to the final destination.
